(19) United States
(12) Patent Application Publication
(10) Pub. No.: US 2007/0185805 A1
(43) Pub. Date: Aug. 9, 2007

(54) Method for providing payment of membership dues from loan pre-payment plan

(75) Inventor: Clifford P. Bendau, Scottsdale, AZ (US)

Correspondence Address: WEISS & MOY PC, 4204 NORTH BROWN AVENUE, SCOTTSDALE, AZ, 85251, US

(73) Assignee: EMPP, INC.

(21) Appl. No.: 11/350,246

(22) Filed: Feb. 8, 2006

(51) Int. Cl. G06Q 40/00

(52) U.S. Cl. 705/38

(57) ABSTRACT

A method for facilitating participation in a loan prepayment plan by participants who also desire the benefits of participation in a dues-requiring membership organization. As part of the benefit of participating in a loan prepayment plan, a participant has all or a portion of membership dues for the membership organization paid by the plan administrator to the membership organization. In one embodiment, such dues are paid from all or a portion of one or more additional principal payments made pursuant to the prepayment plan. In one embodiment, the underlying loan is a mortgage.

### FIELD OF THE INVENTION

The present invention relates generally to membership dues payments and loan pre-payment plans and, more particularly, to a method for providing for payment of membership dues from participation in a loan pre-payment plan.

### BACKGROUND OF THE INVENTION

There are a number of existing plans that facilitate the early payment of a loan, such as a mortgage. One such plan is a biweekly mortgage payment plan. The primary purpose of a biweekly payment plan is to reduce the overall mortgage interest paid by a borrower to the lender through regular automatic prepayments to the mortgage loan. By enrolling in one type of biweekly payment plan, for example, a borrower agrees to have one-half (½) of the regular monthly loan payment automatically withdrawn from a checking or savings account every two weeks. Loan payments are remitted to the lender each month from funds collected over the preceding month. Over the course of each calendar year, a total of twenty-six (26) biweekly drafts, or the equivalent of thirteen (13) regular monthly payments, is collected from the borrower and paid to the lender. The extra payments are applied to the principal balance, reducing the overall interest paid over the term of the loan. In the case of a mortgage loan, this can amount to substantial mortgage interest savings, and can cause the mortgage to be paid in full several years ahead of the scheduled maturity date.

Participants in a biweekly payment plan may choose to further accelerate the payoff of their loan by increasing the regular monthly payment on which biweekly drafts are based. Alternatively, they may forgo the biweekly schedule altogether in favor of weekly, semi-monthly or monthly drafts. In such cases, the monthly payment amount on which these drafts are based should be increased by some amount in order to achieve the benefits of prepayment.

Unrelated to loan prepayment plans, membership organizations typically require payment of periodic dues, generally in the form of annual dues. Membership organizations may have access to significant numbers of individuals who may qualify for participation in a particular type of loan prepayment plan but who, for whatever reason, have not been solicited for such participation or who have not previously agreed to participate.

The present invention is concerned with a method for combining the benefits of participation in a loan prepayment plan with the benefit of having membership dues paid on behalf of a plan participant by a plan administrator.

### SUMMARY OF THE INVENTION

In accordance with one embodiment of the present invention, a method for providing for payment of membership dues is disclosed. The method comprises: a plan administrator facilitating participation in a loan prepayment plan by a participant; and the plan administrator facilitating payment of membership dues in a membership organization by the participant who has agreed to participate in the loan prepayment plan.

In accordance with another embodiment of the present invention, a method for providing for payment of membership dues is disclosed. The method comprises: a plan administrator facilitating participation in a loan prepayment plan by a participant; wherein the loan prepayment plan is a mortgage prepayment plan; the plan administrator receiving a payment from the participant; and the plan administrator delivering at least a portion of the payment to the organization.

### BRIEF DESCRIPTION OF THE DRAWINGS

FIG. 1 is a flow chart illustrating steps in a method consistent with an embodiment of the present invention.

### DETAILED DESCRIPTION OF THE PREFERRED EMBODIMENTS

As used herein, the term “plan administrator” is intended to mean an entity that administers a loan prepayment plan. The plan administrator may itself be the lender for the loan that is the subject of the plan, or may be a third party. A “participant” is an individual or entity that participates in a loan for which a prepayment plan is available, and who also qualifies for membership in an organization. A “loan” may be any type of loan for which a prepayment plan may be available, including for example a mortgage loan, a car loan, a student loan, a credit card balance, etc.

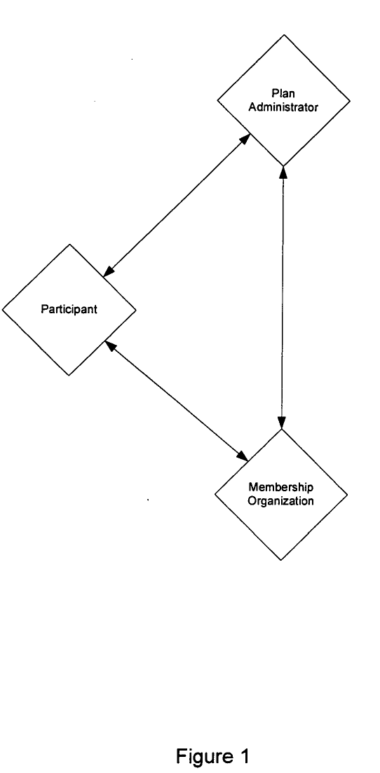

In one embodiment, a loan prepayment plan is a plan, like that biweekly mortgage plan described above, where one or more additional periodic payments is obtained from a participant and applied directly to the principal balance due on the loan. Referring to FIG. 1, in this embodiment, there is an agreement between a membership organization and plan administrator and/or lender, pursuant to which all or a portion of the membership dues for a plan participant are paid by the plan administrator/lender from one or more of the additional periodic payments. FIG. 1 illustrates the relationships between these actors.

It should be noted that the membership organization may wish to facilitate solicitation to one or more groups of persons/entities who are potential participants. Solicitation may be facilitated to existing members, to previous members, and/or to potential members. Any of these may benefit from the method of the present invention. From the point of view of the membership organization, a particular premium may be placed on the use of the method of the present invention to bring in new members, but the benefit of increased retainability of existing members would also be significant.

Thus, rather than requiring a participant to pay an up-front membership fee, that fee is instead deducted from the extra principal portion of any additional payments paid by the participant pursuant to a prepayment plan. In the case of a biweekly payment plan, membership dues can be deducted from the first scheduled principal balance curtailment that occurs naturally in the biweekly draft/payment cycle, usually within the first 5-7 months of enrollment. If the principal curtailment is collected on a weekly, semi-monthly or monthly basis, membership dues can be deducted from the curtailment portion of the first monthly payment(s) remitted to the lender. In either scenario, no separate membership fee payment is required, as it is paid directly out of the funds already collected from the participant.

Furthermore, once a prepayment plan participant has been enrolled, the program may allow for recurring periodic (e.g., annual) membership renewals by deducting membership dues from subsequent principal curtailments.

The following examples are illustrative of this embodiment:

1. Payment cycle Example-Biweekly payment plan

The following example is based on a biweekly payment plan for a mortgage loan, with drafts occurring on alternate Wednesdays beginning Jan. 11, 2006. The monthly mortgage payment of $1,000 is due on the first day of each month, and the membership organization in which the participant is a member charges an annual membership fee of $100.

In this example, two half payments of $500 each are drafted from the borrower's bank account on January 11 and January 25. The total $1,000 collected is remitted as a regular payment on February 1. This process is repeated in February, March, and April. In May, $500 drafts are collected on the 3^{rd}, 17^{th} and 31^{st} of the month, totaling $1,500. The additional $500, which would normally be applied in its entirety to the mortgage principal balance, is reduced by $100 to cover the first year's membership fee. The June 1 payment remitted to the lender will be $1,400, of which $400 is a principal curtailment.

Continuing with this example, from June through Octobeer, the borrower is drafted twice per month, with no additional principal applied to the mortgage. Again in November, three drafts are collected before the December payment (on the 1^{st}, 15^{th} and 29^{th} of the month). Since the annual membership fee has already been paid, this time the entire $1,500 collected is remitted to the lender, with $500 applied as a principal curtailment.

If the membership fee is charged annually, the plan may be permitted to allow the above process to repeat itself the next year, with the fee being deducted from the first scheduled principal curtailment.

2. Payment Cycle Example-Automatic Monthly Drafts

The following example is based on a loan prepayment plan that involves regular monthly withdrawals. In this example, in order for any monthly payment plan to accelerate the payoff of a loan, each payment must be greater than the regular (or minimum) payment. For this example, the same $1,000 monthly mortgage payment is assumed as above, but in this case the participant has elected to add 1/12 of the payment amount to his or her monthly draft, making the equivalent of 13 mortgage payments per year, which results in approximately the same interest savings as a biweekly plan.

Based on the above assumptions, each month's draft will be $1,083.33, with $83.33 designated as a principal curtailment. However, because a $100 membership fee is due, the first month's payment to the lender will be $1,000, not $1,083.33. After $83.33 is applied to the outstanding membership fee, an additional $16.67 remains to be paid from the next month's extra principal payment. The amount remitted to the lender in the second month is therefore $1,083.33−$16.67=$1,066.66, of which $66.66 is applied as a principal curtailment. Since the full membership fee has now been paid, the remaining 10 drafts will be remitted to the lender in full.

The benefits of a method according to any of the embodiments described herein are several. For participants, in addition to the implied benefits of membership in the membership organization, the participant obtains the benefits that accrue from participation in a loan prepayment plan, with the convenience of having both loan payments and membership dues paid automatically through a fixed periodic (e.g., weekly, biweekly, semi-monthly or monthly) draft from a checking or savings account or the like.

The plan administrator also benefits. It obtains the ability to solicit the membership organization's existing and potential membership base, and thereby increase overall participation in the prepayment plan. For the membership organization, the method of the present invention may provide a powerful vehicle for recruiting new members and retaining existing members. Where participation in the plan not only provides current membership in the membership organization but also provides for the automatic renewal of that membership year after year, participants are likely to remain in the membership organization as long as they are active participants in the plan, unless they request otherwise.

It should be noted that various modifications to the method described herein may be possible, without departing from the spirit or scope of the present invention. For example, while membership dues may be paid in full from the additional payments provided by the participant, it may be desired to only have some percentage of the membership obligation paid in this fashion, with the member paying the remainder directly. In addition, the plan administrator may pay membership dues, in one embodiment, from the proceeds of plan closing fees or an interest payment, rather than from the proceeds of an additional, principal payment. Other variations may also be possible, such as drafting a fraction of the membership fee monthly in a monthly prepayment plan.

1. A method for providing for payment of membership dues comprising:
a plan administrator facilitating participation in a loan prepayment plan by a participant; and
the plan administrator facilitating payment of membership dues in a membership organization by the participant who has agreed to participate in the loan prepayment plan.

2. The method of claim 1 wherein the loan prepayment plan is a mortgage prepayment plan.

3. The method of claim 2 wherein the mortgage prepayment plan is a biweekly mortgage prepayment plan.

4. The method of claim 2 wherein the mortgage prepayment plan is a monthly mortgage prepayment plan.

5. The method of claim 1 further comprising:
the plan administrator receiving a payment from the participant; and
the plan administrator delivering at least a portion of the payment to the organization.

6. The method of claim 5 wherein the payment is a principal-only payment pursuant to the loan prepayment plan.

7. The method of claim 1 wherein the membership dues are annual dues for a first year.

8. The method of claim 7, further comprising facilitating payment of membership dues for a plurality of years.

9. The method of claim 1 wherein the loan prepayment plan is one of a weekly, bi-weekly, semi-monthly, monthly, quarterly and annual plan.

10. A method for providing for payment of membership dues comprising:
a plan administrator facilitating participation in a loan prepayment plan by a participant;
wherein the loan prepayment plan is a mortgage prepayment plan;
the plan administrator receiving a payment from the participant; and
the plan administrator delivering at least a portion of the payment to the organization.

11. The method of claim 10 wherein the mortgage prepayment plan is a biweekly mortgage prepayment plan.

12. The method of claim 10 wherein the mortgage prepayment plan is a monthly mortgage prepayment plan.

13. The method of claim 10 wherein the payment is a principal-only payment pursuant to the loan prepayment plan.

14. The method of claim 10 wherein the membership dues are annual dues for a first year.

15. The method of claim 14, further comprising facilitating payment of membership dues for a plurality of years.

16. The method of claim 10 wherein the mortgage prepayment plan is one of a weekly, bi-weekly, semi-monthly, monthly, quarterly and annual plan.
